(19) United States
(12) Patent Application Publication
(10) Pub. No.: US 2019/0066377 A1
(43) Pub. Date: Feb. 28, 2019

(54) SYSTEMS AND/OR METHODS FOR VIRTUAL REALITY BASED PROCESS OPTIMIZATION

(71) Applicant: Software AG, Darmstadt (DE)

(72) Inventor: Harald SCHOENING, Dieburg (DE)

(21) Appl. No.: 15/683,242

(22) Filed: Aug. 22, 2017

(51) Int. Cl. G06T 19/00; G06Q 10/06

(52) U.S. Cl. CPC G06T 19/003; G06Q 10/067; G06Q 10/0633

(57) ABSTRACT

Certain example embodiments relate to deriving process optimizations for a modeled process based on how users interact within a virtual reality environment. A model store stores a first representation of a process comprising process steps. A virtual reality model store stores a second representation thereof. A concept map stores mappings between counterpart concepts from the first and second representations. Output from virtual execution of the process in a virtual reality environment presented using the second representation is received; a part of the second representation associated with the output is identified; a rule set is executed on the output to detect an anomaly; and responsive to a detection of an anomaly, the concept map is consulted to identify a part of the first representation associated with the identified part of the second representation, and the identified part of the first representation is annotated with attributes of the anomaly.

### TECHNICAL FIELD

Certain example embodiments described herein relate to systems and/or methods for virtual reality based process optimization. More particularly, certain example embodiments described herein relate to techniques for deriving process optimizations applicable to a modeled process based on how users interact within a virtual reality environment.

### BACKGROUND AND SUMMARY

In order to operate at all, organizations typically perform many different processes of many different types. Generally speaking, process types can be decomposed into management processes, operational processes, and supporting processes. Management processes may be thought of as being processes that govern the operation of a system. Typical management processes include, for example, “corporate governance,” “strategic management,” etc. Operational processes may be thought of as processes that constitute the core business and create the primary value stream. In today's economy, operational processes can range from industrial processes like bending steel and forming glass to more service-related activities like taking orders from customers, initiating product shipment, logistics management, etc. A complex organization may include numerous operational processes that involve physical product manipulations and movements and services-related to those physical products, and so on. Supporting processes may be thought of as those processes that support core processes including, for example, health and safety, accounting, recruitment, call center, technical support, and/or other processes.

A process relevant to an organization oftentimes begins with a mission objective and ideally ends with achievement of the objective. Process-oriented organizations break down the barriers of structural departments and try to avoid functional silos. A complex process may be decomposed into several sub-processes, each of which may have its own attributes and objectives while still contributing to the achievement of the goal of the super-process.

It oftentimes is in the interests of an organization to analyze and improve its processes. Process analysis can be beneficial, for example, in identifying choke points, areas where processes can be simplified and/or streamlined, opportunities to automate using computer or other technologies, etc. In general, a well-defined process can add value for the organization and possibly end-customers of the organization (who might be internal or external to the organization). Thus, a well-designed process can increase effectiveness (providing value) and efficiency (lowering resource utilization).

The analysis, optimization, and orchestration of processes typically includes the mapping of processes and sub-processes down to activity/task level. Because organizations these days are oftentimes large and complex and involve many kinds of processes and sub-processes acting on a variety of different inputs and outputs, process analysis is aided, and sometimes made possible in the first place, by using analysis computer-based modeling tools.

To enable computer-based analysis and computer-based control, processes typically are modeled using a formalized or semi-formalized computer-understandable modeling language. A number of languages, notations, and techniques are available in this regard. For instance, the Business Process Modeling Notation (BPMN) is a process modeling technique that can be used for drawing business processes in a workflow. Another popular notation for modeling processes involve event-process chains (EPCs).

Because a process can be thought of as being a sequence of related activities in an organization with the purpose of producing products or services (output), it follows that a process can, as alluded to above, range from a series of human activities (providing, for example, a non-digital service) to the control of a production system with a fully-automated sequence of mechanical and/or digital actions.

In the latter case, the process model (regardless of the notation chosen) can be used to control the real process, e.g., to trigger the execution of the process actions (process automation). A process execution system such as webMethods BPM, for example, can trigger automated steps (e.g., the operation of a punching machine, a bank transaction, an order from a supplier) and initiate manual processes by instructing a human to perform a certain task (and after completion of this more manual task, continue on with the next steps due) in the correct sequence and depending on the results of previous steps.

There are various approaches to use the process model for execution control. For example, one paradigm involves computer tool controlled transformation of process models into corresponding workflow descriptions that are interpreted by a computerized process execution tool. This approach, for example, is implemented in the Software AG model-to-execute approach. Another paradigm involves the direct interpretation of a process model by a tool such as Software AG's APG. As demonstrated in a recent CeBit exhibit, the production of agricultural vehicles can be fully automated with this approach.

An automatically executed process (model) thus can include automated activities only (e.g., machine actions such as screwing or welding), or a combination of such automated activities with manual activities that might require manual feeding of some material into a machine. In this latter case, the automation may provide a worker with a detailed work instruction at the very moment the activity is needed, and ideally automatically recognize (e.g., by appropriate sensors at the machine) that the step has been executed. The worker may have to confirm the completion of the activity, e.g., by pressing a button, when automatic recognition is not possible. It thus will be appreciated that computer-controlled process orchestration thus can perform well in areas where there is less than fully-automated action.

It will be appreciated that process models suitable for automation of processes that involve automated and/or manual steps can be derived by various techniques, e.g., by logging the activities performed in a real-world process and deriving a process model that captures the observed sequence of activities, having a process analyst or designer model the process based on domain knowledge (and maybe real-world observations), etc. In both cases, several notations are available to express the process model, e.g. EPC or BPMN.

Generally speaking, process optimization typically includes retrieving process performance information from a modeling or monitoring phase, identifying potential or actual bottlenecks and potential opportunities for improvements, and applying those enhancements in the design of the process. Process discovery and process mining tools also are able to help discover and address critical activities and bottlenecks. Process mining, for example, is known by those skilled in the art to be a process management technique that allows for the analysis of processes based on, for example, event logs. During process mining, specialized data-mining algorithms may be applied to event log datasets, e.g., in order to identify trends, patterns, and details included in event logs recorded by an information system. Process mining in general aims to improve process efficiency and understanding of processes.

Useful for process analysis, optimization, and control, EPCs and BPMN (referred to above) can be used like a high-level graphical programming language to “program” computer-executable sequences of steps that can be computer-executable themselves (e.g., calls to a web service, program execution, IT-controlled production steps), describe a human action, etc. Typically, both types of steps are present in a “process program,” such that a computer can control the execution of the sequence of steps by performing the computerized steps in the given sequence and instructing a human to perform a “manual” step when the preceding automated steps have been executed. Performance of a computerized step is typically achieved by executing a program or service call that is attached to the step as an annotation. This allows for a two-level programming approach, where the overall structure (sequence) can be provided on a graphical, easily-comprehensible level. Computer-controlled sequences of steps (including branches, loops, etc., as known from common programming language) correspond to processes, whereas the overall “programs” may be thought of as being “process models.”

Referring once again to optimization techniques, it will be appreciated that typical approaches to optimizing formalized processes (including those formalized using BPMN, EPCs, and the like) involve capturing data related to real process executions and their steps, analyzing the captured, data, and deriving possible optimizations, e.g., by looking at bottlenecks, exceptional long-step execution durations, and/or the like. The ARTS family of products available from Software AG supports this approach of optimization.

Unfortunately, however, this approach requires processes to be executed in a real environment and typically in a large number, e.g., so that real data of a suitable sample size can be obtained. As a consequence, processes oftentimes cannot be optimized, or reliably optimized, unless they are in use for some time.

Another method supported by ARTS is the simulation of processes based on a process model. The simulation can be used for process analysis and process optimization. Based on process models and organizational structures, for example, the simulation can enable a comparison of actual and target processes in terms of executability and efficiency. A focus also can be placed on costs, execution time, resource usage, and/or the like. This approach can help answers questions regarding throughput times, weak points, bottlenecks, resource requirements, etc.

This particular simulation approach is driven by assumed quantities and numbers. Moreover, these factors have to be explicitly modeled by the creator of the simulation. The simulation unfortunately is not based on real users performing the process and is subject to potential errors made with respect to assumptions, divergences between the real world and the simulated world, etc.

Machine producers sometimes create a “digital twin” of their physical machines. A digital twin is thus a virtual counterpart to a real world device, e.g., a production machine. A digital twin is often generated on the basis of the real object's 3D design. Digital twins are not just 3D models of their counterpart machines and not only mimic the visual representations of their real-world counterparts, but can also mimic the machines' behaviors in a virtual world.

The research project ELISE (http://elise-lernen.de/) develops an interactive and emotion-sensitive learning system for the development of business process management competencies. The integrated hardware/software system is laid out as “serious game” that enables students the virtual walk-through of business processes that are virtualized in a 3D and multi-media fashion. The project combines innovative man-machine-communication and innovative didactic concepts in the area of “gamification” and “embodiment” for various demographic target groups.

The project makes use of virtual reality glasses to enable the walk-through of students through a virtual world that embodies the business process. The business process is considered fixed, and students are to learn the process by (virtually) performing it/walking through it. The learning speed can be adjusted based on biomedical sensors placed on the student's body. When increased values of blood pressure, etc., indicate stress, the learning speed can be lowered; when the sensors suggest a bored users, speed can be increased.

Still, it would be desirable to move beyond this learning and game-based approach. For instance, it would be desirable to be able to adapt this approach to learn about process performance rather than teaching about how it is to be performed, e.g., so as to enable process optimization to take place.

In view of the foregoing, it will be appreciated that the creation of process models based on logging the activities performed in a real-world process and deriving a process model that captures the observed sequence of activities does not work when entirely new processes are to be established. Furthermore, whether process models created by a process designer are complete and best-suited (or even well-suited) for the task at hand cannot be tested. And although simulations based on a model may in some instances be identify bottlenecks, etc., within the model, they may not be able to identify missing steps, points of stress, etc. Simulations also may be subject to the design assumptions build into them, may not reflect divergences between the modeled world and the real world, etc. Moreover, as shown above, processes typically cannot be optimized unless they are in use for some time (e.g., to capture their behavior), or are simulated based on assumed numbers.

Thus, it will be appreciated that it would be desirable to overcome the above-described and/or other limitations when it comes to computer-represented models. For example, certain example embodiments advantageously have users execute a process in a virtual environment (e.g., using virtual reality techniques) and use the result to derive process optimizations, models, and/or the like. In addition, the effectiveness and efficiency of the human interactions within a process can be measured indirectly by, for example, observing execution times (from the moment a worker gets an instruction to perform an activity until the completion of the activity), as well as more directly within the virtual environment, e.g., capturing “human factors” that can cause delays or other issues.

One aspect of certain example embodiments relates to the ability to derive new process models by observing activities without the need to perform the process in reality, by creating a virtual world that models the physical process (e.g., a factory floor, machines and their behaviors, etc.). In some instances, this approach can be performed even before the factory is built and/or even before the machines are installed. Thus, the time to implement an automated process execution in a real environment can be significantly shortened, in at least some instances.

Another aspect of certain example embodiments relates to detecting process issues by observing “real” process execution in a virtual environment. Advantageously, and in contrast to some conventional testing approaches, issues may not cause any “real harm” before they are detected and resolved.

Another aspect of certain example embodiments relates to performing process optimizations without processes needing to be implemented in the real world. Advantageously, roll-out of already-optimized automated, semi-automated, and manual processes in the real environment becomes possible in some instances.

Still another aspect of certain example embodiments relates to detecting worker unease that otherwise might not be detectable in the performance of the process. For example, as worker unease can lead to earlier tiredness of the worker, decreased worker focus, the possibly worker health issues, etc., detection and subsequent elimination or mitigation of the root or other causes of such uneasiness can benefit the worker's health while also increasing production quality, decreasing downtime, etc.

Still another aspect of certain example embodiments relates to the ability to test process optimizations in the same virtual environment and also to compare such process optimizations with the original process. Thus, the optimization benefits that are gained by the optimization can be measured and quantified in certain example embodiments.

In certain example embodiments, a workflow improvement system is provided. A model store is configured to store a first computer-understandable, formalized representation of a process comprising process steps. A virtual reality model store is configured to store a second computer-understandable, formalized representation of the process and process steps, with the first and second representations being different from one another. A concept map is configured to store mappings between counterpart concepts of the process that are present in the first and second representations. The system further includes at least one processor and a memory including instructions that are executable by the at least one processor to control the system to at least: receive output from virtual execution of at least a portion of the process in a virtual reality environment presented in connection with the second representation stored in the virtual reality model store; identify a part of the second representation associated with the received output; execute a rule set on the received output to detect anomalous behavior in the virtual execution; and responsive to a detection of anomalous behavior, consult the concept map to identify a part of the first representation associated with the identified part of the second representation, and annotate the identified part of the first representation with attributes of the anomalous behavior.

In certain example embodiments, there is provided a method for improving a process comprising process steps, with the process being represented by first and second computer-understandable, formalized representations thereof, and with the first representation being in a process modeling language and the second language being in a virtual reality format. Output from virtual execution of at least a portion of the process in a virtual reality environment presented in connection with the second representation is received. A part of the second representation associated with the received output is identified. Using processing resources including at least one processor and a memory, a programmable rule set is executed on the received output to detect anomalous behavior in the virtual execution, with the rule set being stored to a non-transitory computer readable storage medium. Responsive to a detection of anomalous behavior, a part of the first representation corresponding to the identified part of the second representation is identified, and he identified part of the first representation is annotated with attributes of the anomalous behavior.

In certain example embodiments, there is provided a non-transitory computer readable storage medium including instructions configured to help improve a process comprising process steps. The process is represented by first and second computer-understandable, formalized representations thereof, with the first representation being in a process modeling language and with the second language being in a virtual reality format. The instructions are executable by at least one processor to perform functionality comprising: receiving output from virtual execution of at least a portion of the process in a virtual reality environment presented in connection with the second representation; identifying a part of the second representation associated with the received output; executing, using processing resources including at least one processor and a memory, a programmable rule set on the received output to detect anomalous behavior in the virtual execution; and responsive to a detection of anomalous behavior, identifying a part of the first representation corresponding to the identified part of the second representation, and annotating the identified part of the first representation with attributes of the anomalous behavior.

In certain example embodiments, According to certain example embodiments, the rule set includes one or more rules configured to distinguish between first and second levels of anomalous behaviors, with the first level of anomalous behavior corresponding to an action performed in the virtual reality environment that cannot actually be performed, and with the second level of anomalous behavior corresponding to an action performed in the virtual reality environment that can actually be performed but is being performed in the virtual reality environment in a manner outside of that which is expected.

According to certain example embodiments, the system is further controllable by the at least one processor to update the first representation to include new process steps performed during the virtual execution and determined from the received output, e.g., to cause subsequent virtual executions of the process to be performed in connection with the new process steps.

According to certain example embodiments, the system is further controllable by the at least one processor to suggest process improvements for, and/or perform process improvements in, subsequent virtual executions and/or subsequent real-world performance of the process.

According to certain example embodiments, wherein each process step in the process is classified as being one of a manual step and an automatic step, and a virtual reality control system is configured to control the virtual execution so as to simulate process steps that are classified as being automatic steps and enable a human user to perform process steps that are classified as being manual steps.

According to certain example embodiments, the virtual reality control system includes at least one physical sensor attachable to the human user and configured to obtain biometric data of the human user, at least one camera configured to track movement of the human user during the virtual execution, and at least one user interface device configured to enable the human user to interact with the virtual reality environment. Receivable output includes data from the at least one physical sensor, the at least one camera, and the at least one user interface device.

A personal state of the human user may be derived based on received output corresponding to data from the at least one physical sensor according to certain example embodiments, e.g., with the personal state including physical and/or psychological states observed about and/or inferred from the human user. The rule set may include at least one rule programmed to take into account a personal state of a human user, and optionally baseline data for that human user and/or a group of human users.

According to certain example embodiments, the attributes of the anomalous behaviors include associated start and end timestamps, as well as associated (a) movements and/or (b) biometric data.

According to certain example embodiments, the system is controllable to respond to a detection of non-anomalous behavior by consulting the concept map to identify a part of the first representation associated with the identified part of the second representation, and annotating the identified part of the first representation with attributes of the non-anomalous behavior.

Corresponding methods and non-transitory computer readable storage mediums tangibly storing instructions for performing such methods also are provided by certain example embodiments, as are corresponding computer programs.

These features, aspects, advantages, and example embodiments may be used separately and/or applied in various combinations to achieve yet further embodiments of this invention.

### BRIEF DESCRIPTION OF THE DRAWINGS

These and other features and advantages may be better and more completely understood by reference to the following detailed description of exemplary illustrative embodiments in conjunction with the drawings, of which:

FIG. 1 is a block diagram with example components of a technological framework that may be used to implement certain example embodiments;

FIG. 2 is an example process representation, provided to help explain how certain example embodiments may operate;

FIG. 3 is a table showing a subset of a vocabulary that may be used in connection with the FIG. 2 example process, and which may be extracted from the virtual reality environment, in certain example embodiments;

FIG. 4 is a table showing an example mapping between virtual concepts and process concepts based on the FIG. 2 example process, which may be built in certain example embodiments;

FIG. 5 is a flowchart showing example phases in which certain example embodiments may operate;

FIG. 6 is a flowchart showing details concerning an example preparation phase from FIG. 5, according to certain example embodiments;

FIG. 7 is a table showing a subset of the vocabulary used in the FIG. 2 example process, which may be extracted therefrom;

FIG. 8 is a flowchart showing details concerning an example observation phase from FIG. 5, according to certain example embodiments;

FIG. 9 is a table providing a sample of data recorded by the monitoring component in accordance with certain example embodiments;

FIG. 10 highlights areas in the FIG. 9 table where there are periods of no movement and no activity;

FIG. 11 is a table showing bio-reading data that is captured, in accordance with certain example embodiments;

FIG. 12 is an example annotation added to a step in the FIG. 2 example process in accordance with certain example embodiments;

FIG. 13 is pseudo-code for a set of example complex event processing (CEP) rules that may be processed on a stream of sensor data to infer a worker's conditions, in accordance with certain example embodiments;

FIG. 14 is pseudo-code for a set of CEP rules that may be processed to detect and correct sensor reading outliers, in accordance with certain example embodiments;

FIG. 15 is another example annotation added to a step in the FIG. 2 example process in accordance with certain example embodiments;

FIG. 16 shows an enhanced process model, which has been changed based on VR observations, in accordance with certain example embodiments;

FIG. 17 is a flowchart showing details concerning an example evaluation phase from FIG. 5, according to certain example embodiments;

FIG. 18 is a sample query for detecting unhealthy movements, which may be used in connection with certain example embodiments;

FIG. 19 is a sample rule set indicating suitable process adaptations based on step-related findings, which may be used in connection with certain example embodiments; and

FIG. 20 is a query that spots periods without movement and stress occurring at the same time, and relates these detections to the previous step in the virtual environment, which may be used in connection with certain example embodiments.

### DETAILED DESCRIPTION

Certain example embodiments relate to systems and/or methods that combine virtual reality and process modeling techniques, e.g., for process optimization and/or other purposes. VR currently is already used to aid in the creation of real objects, e.g., using artifacts that have been created in the virtual world beforehand. In certain example embodiments, VR techniques can be used to enable processing steps already defined in a process modeling environment to be “performed” in the virtual world. A worker may execute the process steps in the virtual world, while bio-sensors and/or the like are used to monitor the worker's behavior, a timer is used to measure the time for each processing function, etc.

By doing so, specific errors or miscalculations relative to the modeled process can be detected and potentially counteracted before the production “goes live.” Additionally, the creation of process models can be facilitated using a VR environment. The resulting model may be more accurate for timing issues, while also potentially showing improved feasibility (e.g., so that no function step is missed out or invalidly placed).

As will be appreciated from the more detailed description that follows, in certain example embodiments, and as further explained below, complex event processing (CEP) techniques can be used to help guarantee a better input from the person acting in the VR environment. Outliers can be detected and the overall reliability of the input for the process assessment may be improved.

As also will be appreciated from the more detailed description that follows, certain example embodiments involve a mapping between VR readings and the effect it shows for the modeled process. A two-stage approach is implemented in this regard, in certain example embodiments. In a first stage, the physical readings are mapped to a personal state, and possible personal states in the second stage are categorized as being one of an error (e.g., something that cannot be done in reality), a problem requiring or at least suggesting process adjustment, and normal behavior in that data fits within expected ranges. A process improvement or correction can be conducted at the precise processing step/function.

### Example Implementation

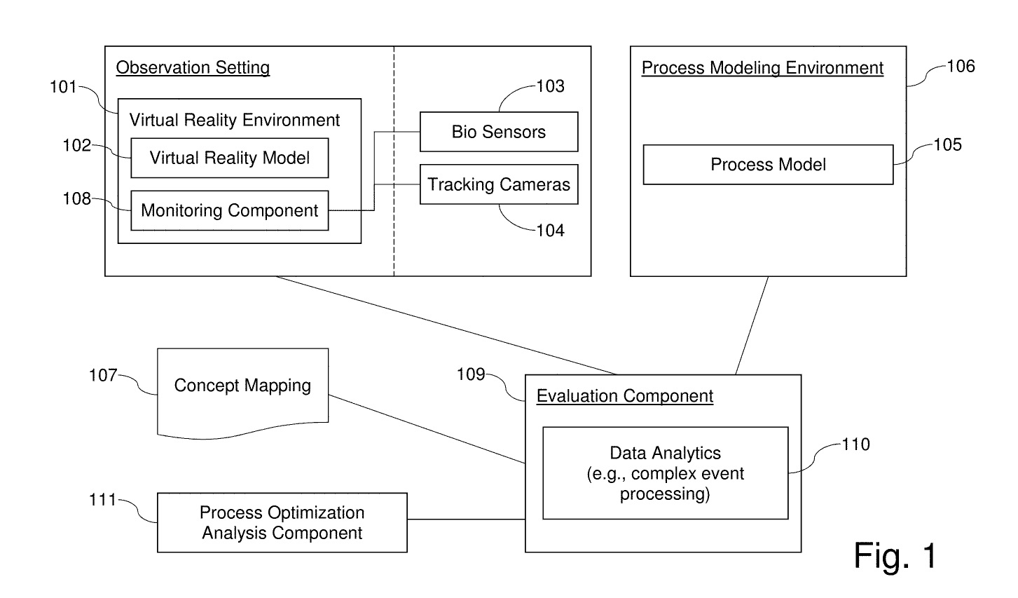

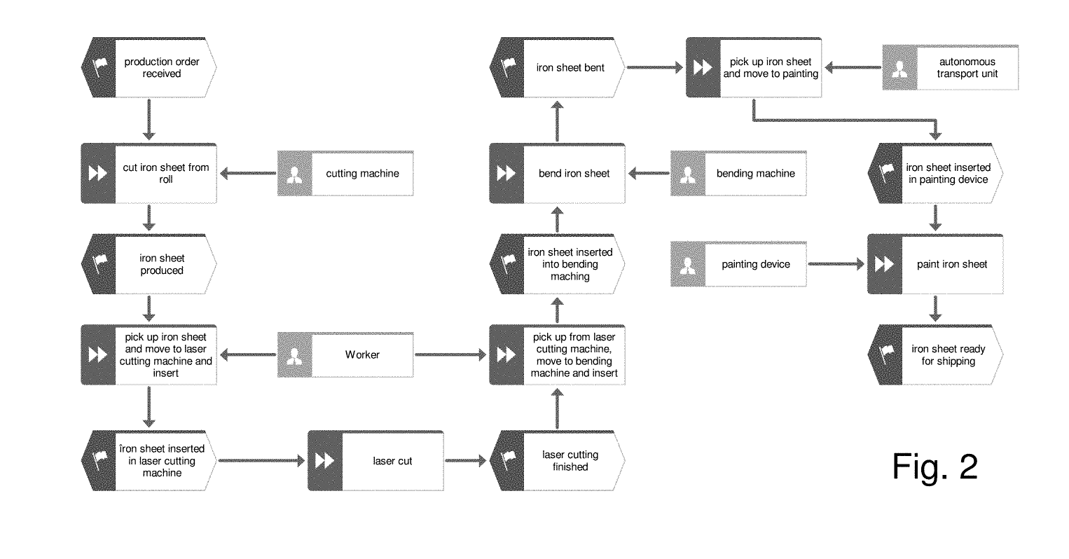

Details concerning an example implementation will now be provided in connection with example hardware components (including those shown in FIG. 1) and with reference to an example process (including that shown in FIG. 2) and information extracted therefrom. It will be appreciated that other hardware and/or software components may be used in connection with different example embodiments. It also will be appreciated that the example techniques set forth herein may be used in connection with a number of other different processes and process types, that other information can be extracted from this and/or such other different processes and process types, etc.

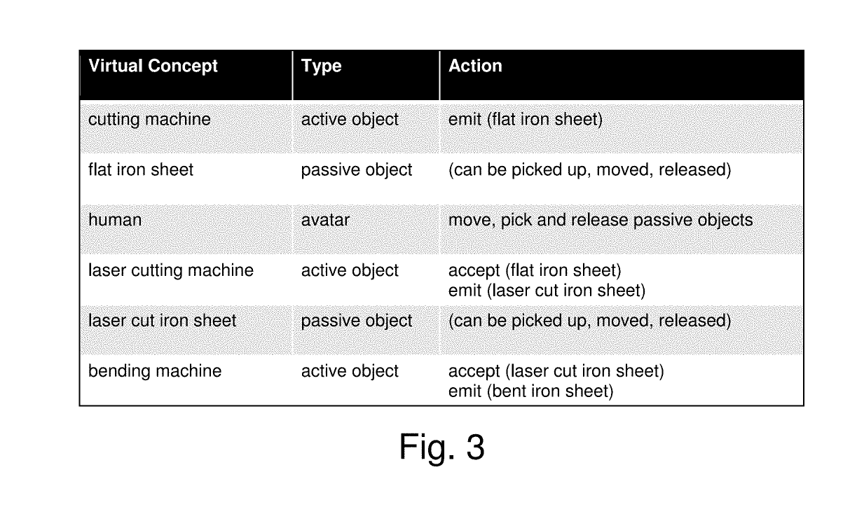

Referring now more particularly to the drawings, FIG. 1 is a block diagram with example components of a technological framework that may be used to implement certain example embodiments. A virtual reality environment 101 mirrors the “world” in which the FIG. 2 example process is executed. The VR environment 101 includes a VR model 102, including relevant concepts (e.g., see FIG. 3 and the description below), and makes use of digital twins where appropriate. The VR model 102 may be backed by any suitable storage medium and may include data regarding concepts, digital twin representations, etc. The VR environment 101 may be implemented using computer technology including, for example, at least one processor and a memory storing the VR model 102. Other hardware elements may be useful in creating aspects of the VR environment 101 including, for example, projectors, heaters/coolers, fans, and/or the like. In general, a VR control system may include the processing resources, VR model 102, monitoring component 108, hardware sensors, cameras, etc.

A user interacts with the VR environment using hardware devices such as, for example, smart data gloves and/or other sensors that track the user's fine grained hand and/or other movements, eye glasses or goggles that track eye movements and/or provide VR images to the user, one or more tracking cameras 104 that track the user's movements, etc. Bio-sensors 103 also may be operably connected to the VR environment 101, e.g., to provide feedback about the user. Such feedback may include, for example, blood pressure, heart rate, body temperature, pulse oximetry data, and/or the like. Known sensors of these and/or other kinds may be used in this regard. The VR environment 101 together with these hardware elements may be thought of as being a part of the observation setting. A monitoring component 108 may be located in the VR environment 101, and it may be configured to record users' behaviors in the created virtual environment. As shown in FIG. 1, the monitoring component 108 may be connected to the hardware (including sensors, cameras, projectors, etc.).

A process modeling environment 106 manages a formal process model 105. The formal process model 105 may be modeled using an EPC, BPMN, or other representation. The process modeling environment may be a software tool executing on a computing platform including at least one processor and a memory, e.g., with the formal process model 105 being accessible to it from a model store or the like that may be backed by a non-transitory computer readable storage medium.

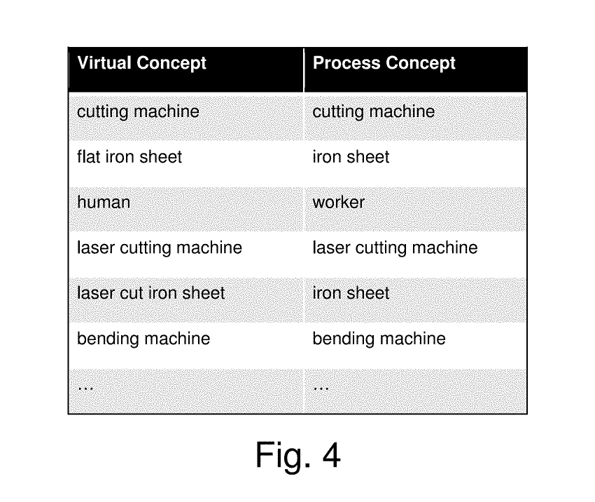

A mapping 107 of the process concepts to concepts in the virtual environment (e.g., as shown in connection with FIG. 4) is stored to a data store. This data store may be a database, dictionary, or the like, including linkages between the two. The mapping 107 may be built manually or automatically, suggestions may be generated automatically and manually confirmed, etc., in different example embodiments.

An evaluation component 109 annotates process models stored in the process model 105 with the findings of the virtual environment walk-throughs, using data analytics 110, manually entered observer notes, etc. In example embodiments where process models are being derived, the evaluation component 109 may be additionally or alternatively used to create the new process model, e.g., based on process discovery, process mining, and/or other techniques. A process optimization analysis component 111 is connected to at least the evaluation component 109 is suggests and/or performs process improvements based on annotations created by the evaluation component 109 as added to the process model 105, etc. Process discovery, process mining, and/or other techniques may be used here, as well, e.g., to help determine what improvements may be desirable. Example techniques include those described in, for example, T. Blickle et al., “Automatic Process Discovery with ARIS Process Performance Manager (ARIS PPM)” Software AG Business White Paper, October 2010; D. Ferreira et al., “Discovering Process Models from Unlabelled Event Logs” in Business Process Management, 7th International Conference, BPM 2009, Ulm, Germany, Sep. 8-10, 2009, Proceedings; D. Ferreira et al., “Using Process Mining for ITIL Assessment: A Case Study with Incident Management” in Proceedings of the 13th Annual UKAIS Conference (2008); and W. van der Aalst et al., “Workflow Mining: Discovering Process Models from Event Logs” in IEEE Transactions on Knowledge and Data Engineering, vol. 16, no. 9, September 2004. The entire contents of each of these publications is incorporated herein by reference. The evaluation component 109 may aid in mapping functions, concepts, etc., from the process model with data from the virtual execution in the VR environment 101. It also may be thought of as including a problem state identifier that operates according to the process model and data from the virtual execution and takes into account the process model and data from the monitoring component 108. In this regard, it may help determine different levels of problems such as, for example, absolute (e.g., a person falls asleep during the process) and relative problems (e.g., a person uses tools out of a prescribed order), errors reflecting something that happened in the virtual world that cannot happen in the real world and problems that happened in the virtual world and are undesirable for the real world, etc.

As indicated above, FIG. 2 is an example process representation, provided to help explain how certain example embodiments may operate. A sample plant produces iron sheets used, e.g., for use as computer cases or coverings. The same production line is used to produce various variants. Those skilled in the art understand the FIG. 2 process. However, to highlight certain aspects of the process that will become more relevant later, a number of operations in the example process will now be described. In the FIG. 2 example, an iron sheet cutting machine cuts a specific iron sheet from a large roll of iron sheet. This cutting process is automated, and the size of the iron sheet to be cut depends on the concrete part to be produced. This iron sheet is then manually picked up by a worker and inserted into a laser cutting machine that creates the desired shape and inserts holes where needed. After that, a worker removes the iron sheet from the laser cutting machine and inserts it into a bending machine. Then, the iron sheet is picked up by an autonomous transport unit and transferred to a painting machine where the desired color is applied.

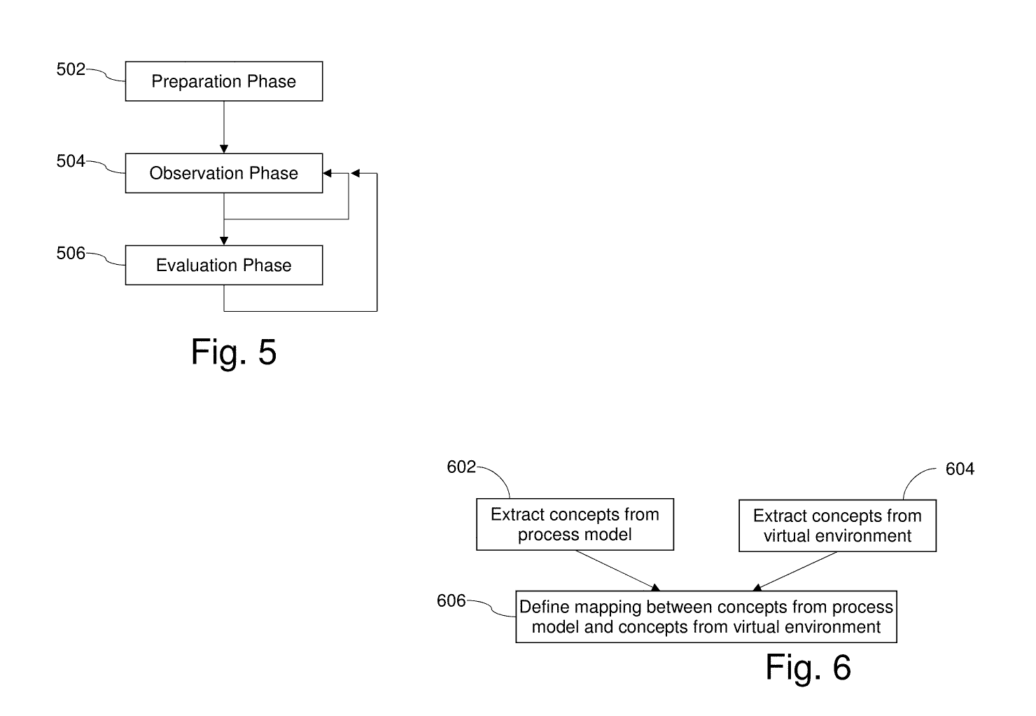

FIG. 5 is a flowchart showing example phases in which certain example embodiments may operate. These phases include, a preparation phase 502, an observation phase 504, and an evaluation phase 506. As will be appreciated from FIG. 5, there may be a loop established between the observation phase 504 and the evaluation phase 506, e.g., as subsequent runs of the process in the VR environment help to provide subsequent information useful for further analysis and/or performance enhancements.

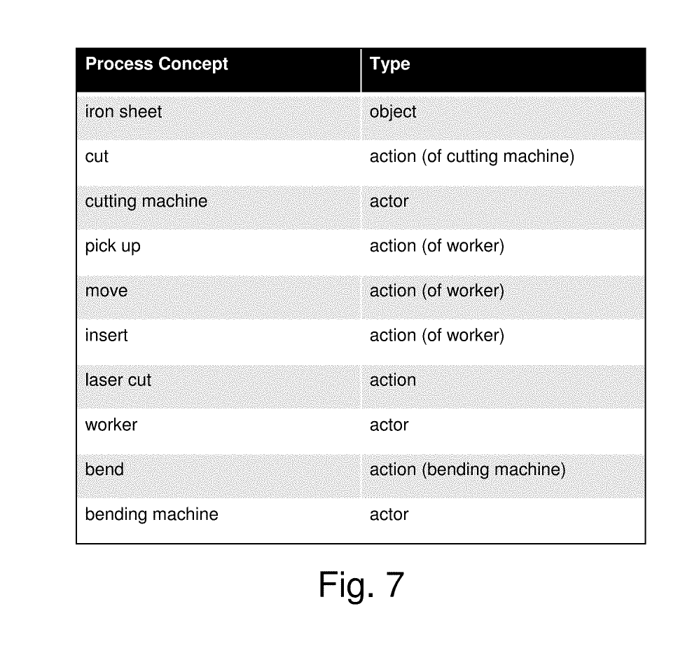

FIG. 6 is a flowchart showing details concerning an example preparation phase 502 from FIG. 5, according to certain example embodiments. As shown in FIG. 6, for a given formal process model, the used concepts are extracted in step 602. FIG. 7, for example, is a table showing a subset of the vocabulary used in the FIG. 2 example process, which may be extracted therefrom. FIG. 7 shows, for example, extracted process concepts and their associated types for this subset and thus is similar to FIG. 3 (as will become clearer from the description that follows).

If the formal process mode follows the usual principles of a well-defined language, which is typical with EPC and BPMN for example, an extraction may be executed in the following straightforward or other manner. The language used in such models is typically quite formalized and allows for the easy identification of objects, actions, actors, etc. These may be thought of as being the concepts shown in the FIG. 7 table and referred to herein. In “event” steps (e.g., steps with the hexagonal shape in FIG. 2 including, for example, the first step corresponding to “production order received”), the text typically includes a (possibly compound) noun and a past participle. The noun is extracted as an “object.” In a “process” step (e.g., green rectangular shapes in FIG. 2 such as the “cut iron sheet from roll” step), the text typically includes a verb in an imperative form, a (possibly compound) noun as an object, and possibly other nouns with other grammatical function (such as, for example, “from roll” in the previously-mentioned step). Nouns are extracted as objects, and verbs are extracted as actions. In the FIG. 2 example, the yellow rectangular boxes denote actors, and the text typically includes the name (role) of the actor. Alternatively, or in addition, concepts may be manually created. Indeed, if the example techniques are used to derive process models, the set of concepts may need to be manually created (e.g., if there is no prior model on which to base the creation of a new model). It will be appreciated that this type of concept extraction need not necessarily be practiced with all embodiments, e.g., as a number of different techniques for vocabulary extraction may be used in different example embodiments. Natural language processing also may be used, for example.

The virtual environment has the notion of objects and their behavior, and the actions that can be performed on objects. These concepts are extracted in step 604 of FIG. 6. FIG. 3 is a table showing a subset of a vocabulary that may be used in connection with the FIG. 2 example process, and which may be extracted from the virtual reality environment, in certain example embodiments. These virtual reality concepts have types and actions, as indicated in the FIG. 3 table. As the virtual environment in this example has been built to simulate the process of FIG. 2, the objects correspond to one another, but it might well be that the virtual environment contains several concepts that are not in the vocabulary of the process in at least some instances, e.g., windows, doors, furniture, etc. Thus, it will be appreciated that the FIG. 2 and FIG. 3 concepts might not have an exact one-to-one correspondence.

These two sets of concepts (that of the process to-be and that of the virtual environment, subsets of which are represented in FIGS. 7 and 3, respectively) are now mapped to each other, e.g., in step 606 of FIG. 6. In this regard, FIG. 4 is a table showing an example mapping between virtual concepts and process concepts based on the FIG. 2 example process, which may be built in certain example embodiments. It will be appreciated that this may be a one-to-many mapping in some instances, e.g., such that multiple concepts of the virtual environment can be mapped to the same concept in a process, but not vice-versa. The mapping 107 in FIG. 1 is expressed in a machine-readable form, e.g., a simple list of pairs (including virtual concept, process concept) may be sufficient for this purpose. More complex representations including, for example, the type of the concept and further information might be beneficial, as may the organization of the mapping data in a database, in certain example embodiments.

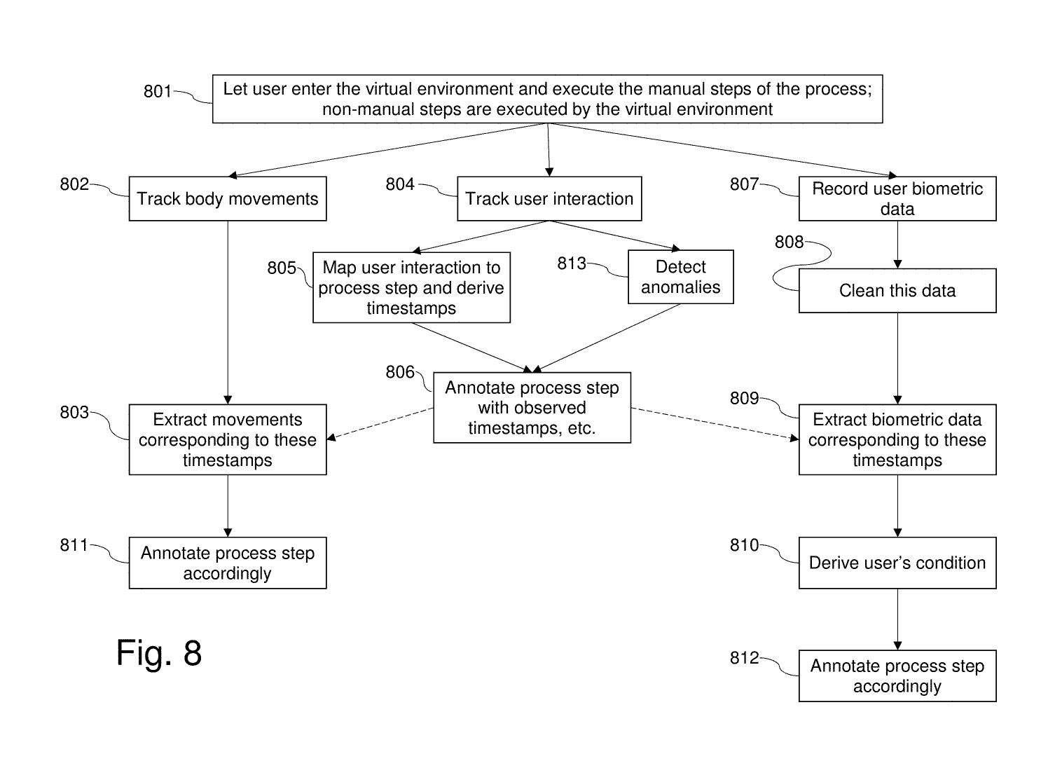

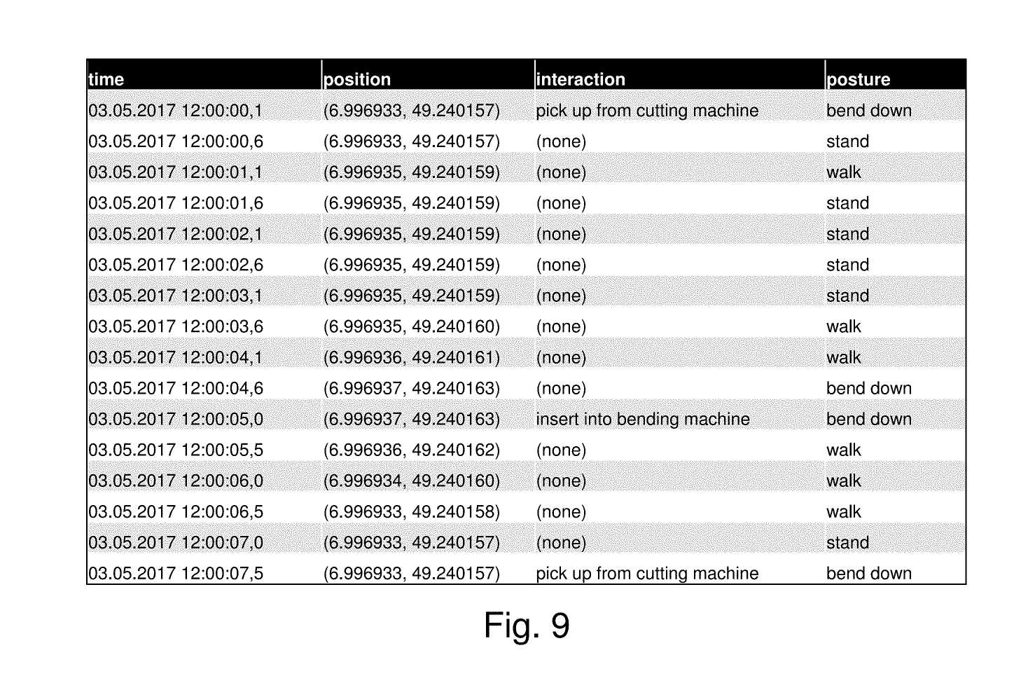

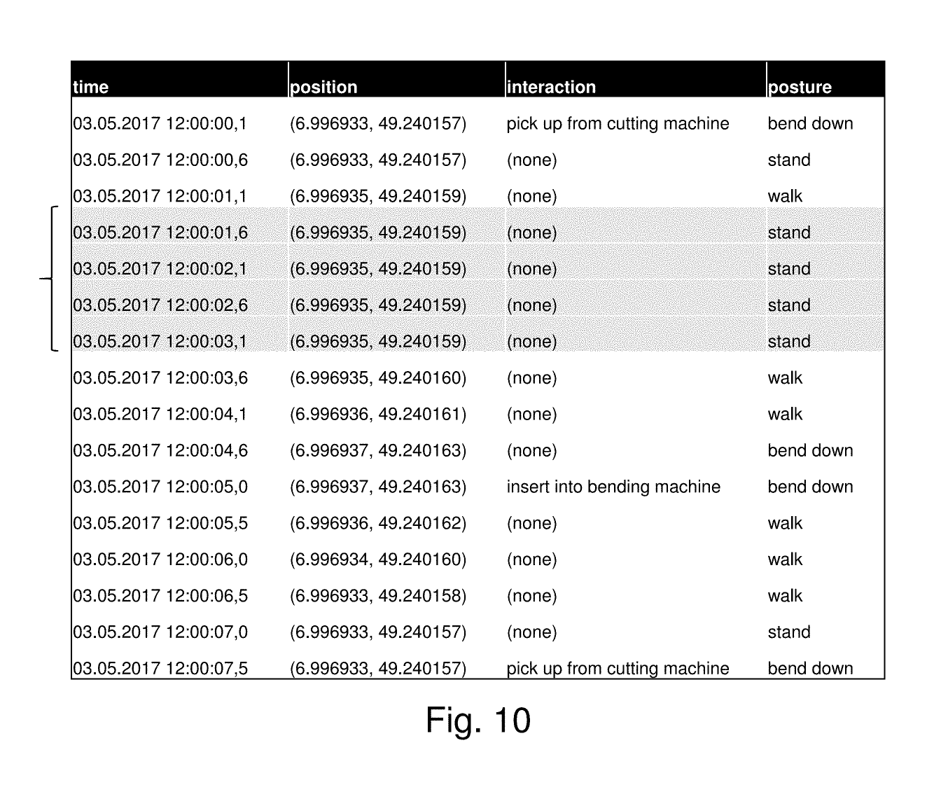

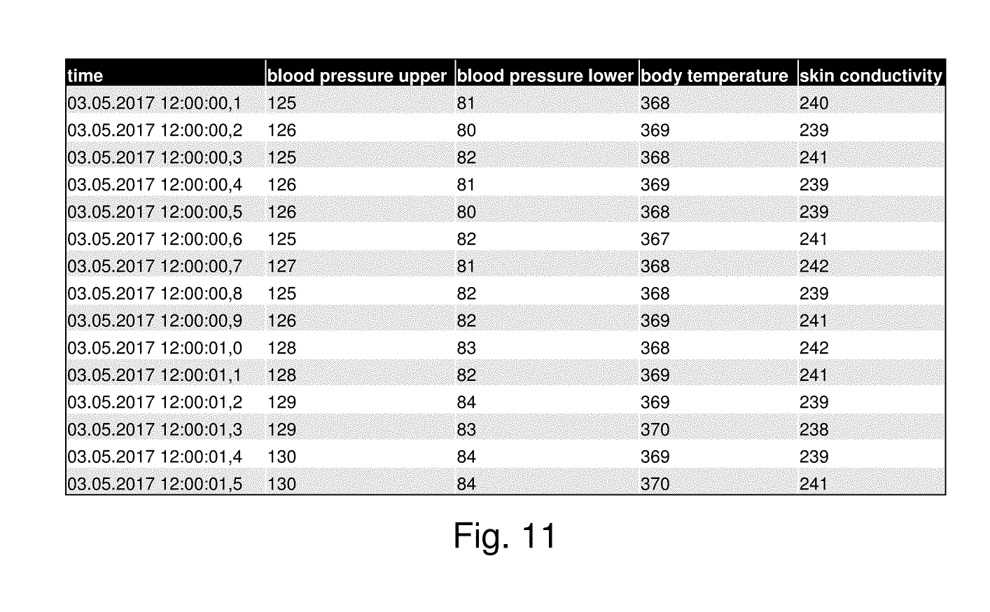

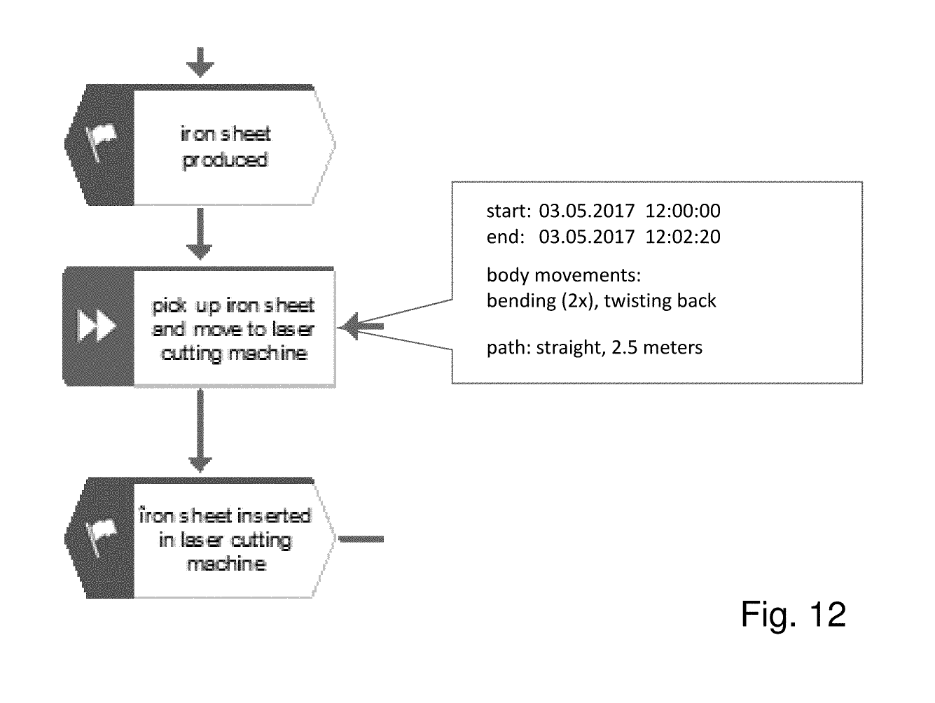

Based on the work done in the preparation phase 502, a sequence of observations can be made. In this regard, FIG. 8 is a flowchart showing details concerning an example observation phase 504 from FIG. 5, according to certain example embodiments. Users (typically the users that are expected to execute the process in the real world) are put into the observation setting and enter the virtual reality environment, and they are instructed to execute the process (or the process to-be) in this virtual environment (step 801). Computerized or automated steps are simulated by the virtual environment, such that the manual steps are left to the user. This may involve making the user wait for a predetermined amount of time that simulates how long an automated process might take, etc. When users interact with the virtual environment, sensors 103 are used to measure bio-indicators such a blood pressure, heart rate, skin conductivity (electrodermal activity EDA, Galvanic Skin Response), temperature, etc. (step 807). The monitoring component 108 tracks the activity of the users in the virtual environment (in step 804), including their movement paths, their interactions with objects in the virtual environment, and the timing of these activities. FIG. 9 is a table providing a sample of data recorded by the monitoring component 108 in accordance with certain example embodiments. The FIG. 9 example shows timestamps, positions interactions, and postures. (FIG. 10 highlights areas in the FIG. 9 table where there are periods of no movement and no activity.) Other information may be stored in addition, or as an alternative, to this information. For instance, data from the sensors and cameras and/or enabling the VR environment to be replayed may be stored in association with this and/or other information. The bio-sensor readings are recorded as well in regular intervals (e.g., ten times a second) and recorded with their timestamps. In this regard, FIG. 11 is a table showing bio-reading data that is captured, in accordance with certain example embodiments. In the FIG. 11 example, values are normalized to avoid non-integer values (e.g., to Centigrade*10). This normalization is performed for illustrative purposes and may be useful in some contexts. Additional cameras 104 and/or other sensors are used to track body movements including, for example, turning, bending, etc. (step 802).

Based on the mapping of the process concepts and the virtual environment concepts, the evaluation component 109 identifies activities of the user in the virtual environment that correspond to steps (step 805). This identification may be performed manually, automatically, or suggestions may be developed automatically for subsequent manual approval. Automatic identification may be aided by inferring where in the process the user is (e.g., based on previously completed tasks, tasks yet to come, tasks performed automatically, etc.), comparing the time elapsed to estimates of how long preceding steps should take, watching for characteristic movements of the body and/or manipulations of objects in the virtual world that are expected to be associated with a given step, etc.

Having identified a step performed by a worker in the process from the virtual activities in this way, the evaluation component 109 annotates these steps with the data recorded in the virtual world, e.g., the timestamps of the virtual actions corresponding to the process steps (step 806), the user activities in between (e.g., movement, body movement, looking around, etc.) (steps 803 and 811), and potentially the number of trials to perform the step, etc.

FIG. 12 is an example annotation added to a step in the FIG. 2 example process in accordance with certain example embodiments. Start and end timestamps are included, as are body movements and features of the path taken. The user activities may be observed and classified using the sensors, cameras, etc. In certain example embodiments, candidate activities may be provided by a user ahead of time, suggested for certain activities automatically (e.g., “pick up” actions might be expected to have “bend over,” “lift,” and other candidate actions, “move” actions might be expected to have path and distance features, etc.), etc. Unknown activities may be flagged for potential subsequent review. In this regard, data sufficient for playback of the whole or a part of a step may be associated therewith. This data may include, for example, information about what the user was doing (as inferred from the sensors, cameras, etc.), information about the step, time information, etc.

When the example techniques set forth herein are used for process creation/derivation, the worker is given a certain task, e.g. described in natural language (e.g., “please produce a computer case”). The activities performed by the worker in the virtual environment are recorded, including the interactions with the active objects (e.g., the digital twins of production machines). Well-known techniques of process discovery, processing mining, and/or the like, may be used to create a process model form the recorded activities. See, for example, the publications identified above.

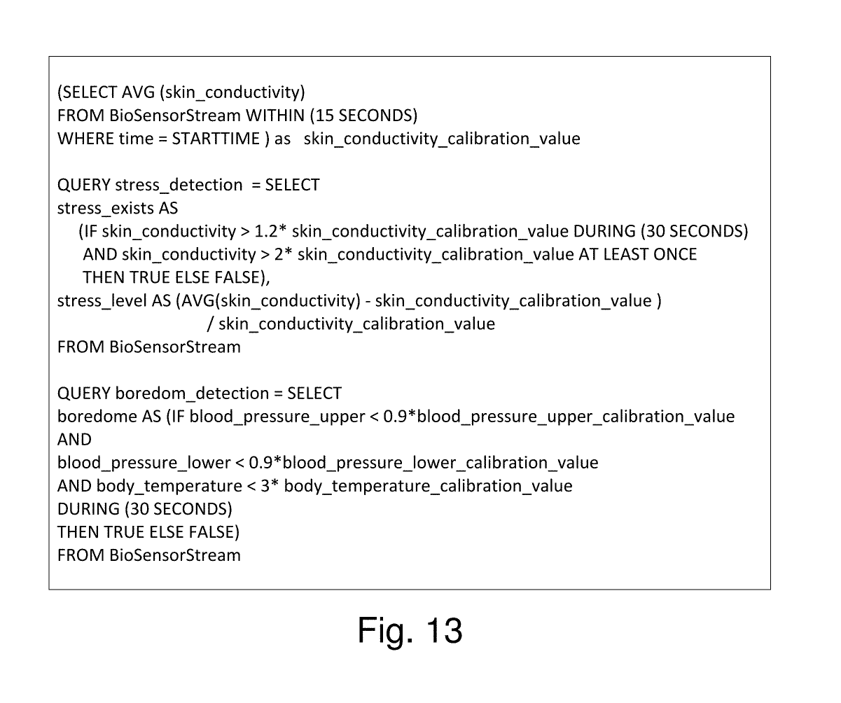

For the time span between two automated process steps (e.g., the time span corresponding to one or more manual steps), data analytics 110 may be used to derive the user's condition (physical and psychological reaction) from the sensor readings (steps 809 and 810). This may include, for example, an increase in stress, boredom, tiredness, and unease. In certain example embodiments, data stream analytics via complex event processing (CEP) may be used in connection with this extraction. For instance, a set of CEP rules may be processed on the stream of sensor data to infer the conditions mentioned above. FIG. 13 shows sample rules (in a pseudo-code notation) that can be used for this purpose. The first rule determines a calibration value for the skin conductivity. This is computed before the worker's activity in the virtual environment start. Calibration values for blood pressure, etc., are taken analogously. More complex rules may also capture the relation of the various bio-data to each other during calibration time. It thus will be appreciated that baseline data may be obtained in certain example instances, e.g., so that changes relative to the baseline may be monitored and treated appropriately. The baselining may be performed relative to an individual and/or a group of individuals (e.g., so that a person who “runs hot” will not trigger alarms when a seemingly elevated temperature is detected, an alarm might be triggered for a modest increase of blood pressure for a person who normally has quite low blood pressure, etc.). In general, rules may identify problem states, taking into account baseline data, and compare them to what is expected with respect to a process step, etc.

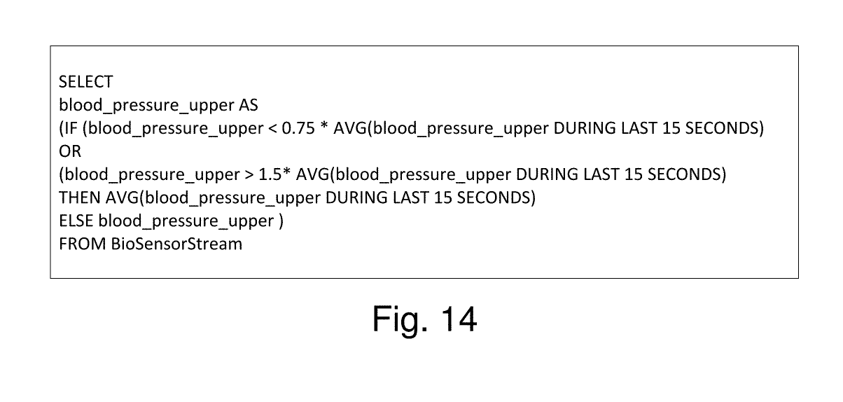

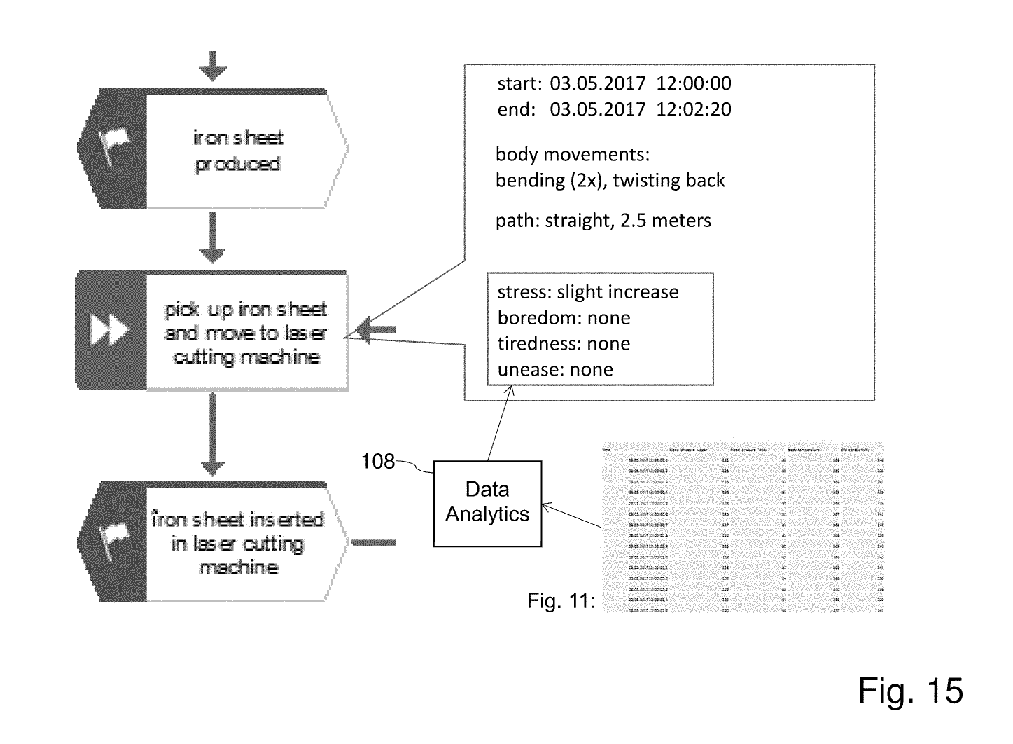

CEP techniques also may be used to clean the data from the sensor readings (step 808). For example, CEP queries can be used to detect and filter outliers in the sensor readings that are caused by temporary sensor mis-readings (e.g., due to a sudden and intense movement of the worker, etc.). In this regard, FIG. 14 is pseudo-code for a complex event processing rule used to detect and correct sensor readings. As will be appreciated, the FIG. 14 example rule is for outlier handling of upper blood pressure readings. As is known, CEP queries oftentimes include engines (which may be enabled by hardware processing resources) that execute continuous queries on event streams and, in this case, event data may be gathered by the sensors, cameras, user interface devices, etc., and delivered to an event bus or the like via the monitoring component 108.

The corresponding step of the process model is then annotated with these findings (step 812). FIG. 15 is another example annotation added to a step in the FIG. 2 example process in accordance with certain example embodiments. FIG. 15 is similar to FIG. 12 and the annotations may be added to the model 105 in a manner similar to that described above in connection with FIG. 12. Rules for determining emotional or psychological states, etc., may be employed in order to derive this data, e.g., as noted above. Bio-indicator data from FIG. 11 is shown to be taken into account, e.g., by the data analytics 108 in this regard.

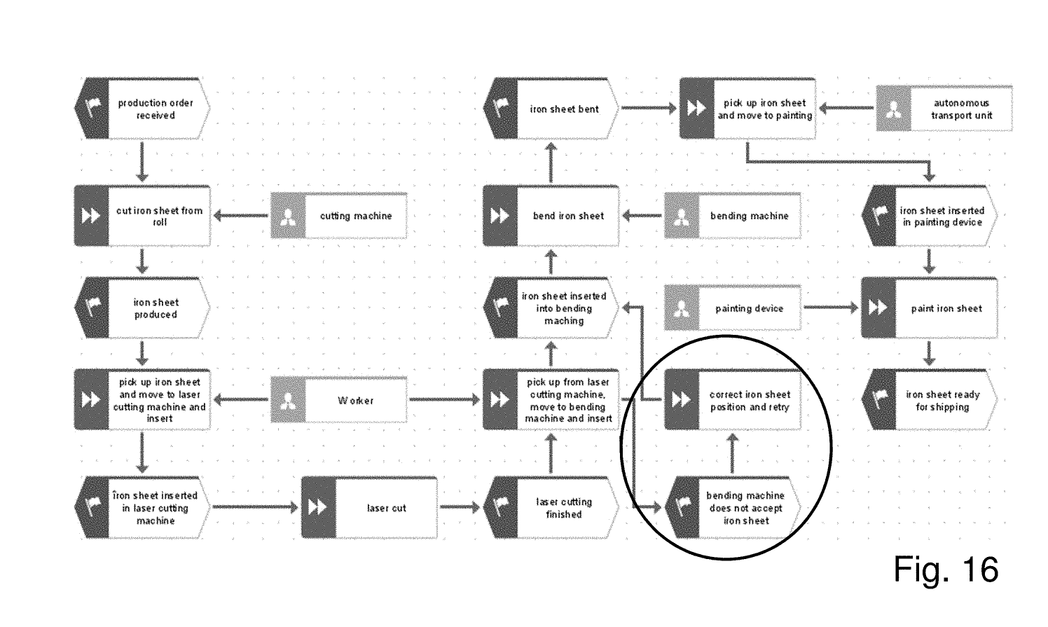

The evaluation component 109 will also detect anomalies (step 813) such as, for example, unexpected actions (if they exist), out-of-sequence execution of process steps, etc. These detections may be used to enhance the process model by providing additional edges or steps. FIG. 16 shows an example of such an enhanced process model. In the case shown in FIG. 16, the worker has inserted the iron sheet in the virtual environment into the bending machine with an incorrect orientation. As a consequence, the worker had to adjust the positioning of the iron sheet. This additional unexpected activity is recorded and the process model is enhanced, accordingly. The circled area indicates the added process steps. The added process steps in this instance indicate a loss of process performance (due to the additional step). By preventing this step by giving clear instructions and interactive help to the worker, for example, the process performance can be increased. The effectiveness of these improvements can then be verified by another process run in the (thus updated) virtual environment. In other instances, different changes to the model may be notated and verified, e.g., to attempt to leverage efficiencies through unexpected (though positive) interactions with the VR environment. The enhanced model (whether negative or positive with respect to the objectives of the process) may be stored in a formalized manner, e.g., to the process model 105.

Typically, the same user will repeat the process in the virtual world multiple times in order to simulate a real worker's shift. The observation phase 504 additionally or alternatively will be repeated with further users.

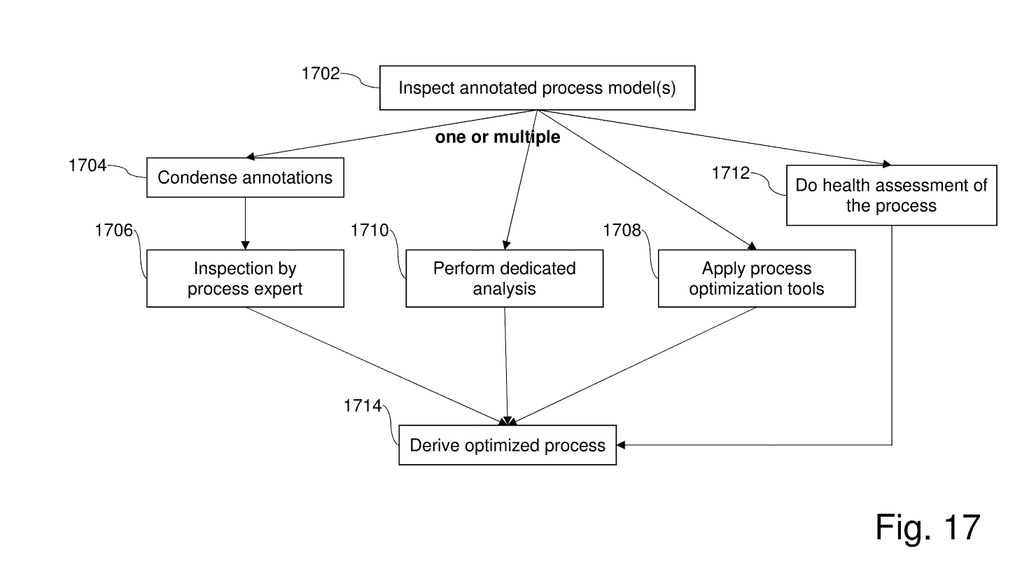

FIG. 17 is a flowchart showing details concerning an example evaluation phase 506 from FIG. 5, according to certain example embodiments. This involves, among other things, inspection of the annotated process models (step 1702). As shown in FIG. 17, the resulting annotated process model can be inspected by process experts (step 1706) to identify optimization potential in the process. For this purpose, the annotations to the process steps may be condensed (step 1704) to make them suitable for human inspection. Such a condensation can, for example, include determining a distribution of worker conditions for each of the process steps, computing averages, etc. This may helpful in the sense that it might be more informative to know that, for example, that in 100 repetitions of a given process step, 60 times a very high stress level was observed, 35 a high level of stress was observed, and 5 times a moderate level of stressed was observed, as compared to providing a listing of the 100 observations. Similarly, an average execution time of a process step may be more easily comprehensible than 100 single values. In some situations, summary groupings may be more helpful than averages. Thus, it may be desirable to provide a flexible approach to visualizing and/or exploring more summary-level or aggregated data, in certain example embodiments. In addition, or in the alternative, tools sets such as ARIS can be used to optimize the process based on the findings in the virtual world (step 1708), e.g., as if they were real world results.

If there are many process executions by multiple workers, manual handling may become cumbersome and data condensation might lead to less accurate insights. However, the data annotated to the process step is well suited to perform automated analyses (step 1710), by the process optimization analysis component 111. As an example, the distance traveled by a worker can be compared to the shortest distance between the machines. Large deviations might be seen to indicate obstacles that can be removed, leading to shorter time for the process step, faster overall process time, potential cost savings, etc.

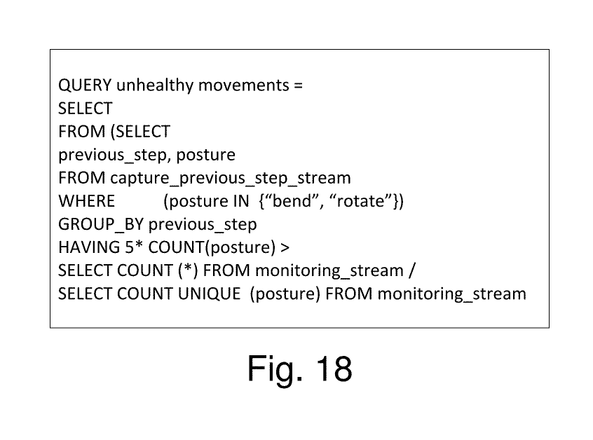

Times without movement of the worker can be spotted, e.g., as noted in connection with FIG. 10. These times could indicate issues with machine operating, confusion, etc. The bio-sensor readings for this time period can be checked as to whether they indicate increased stress levels using the data analytics as described above and exemplified in FIG. 13. It will be appreciated that FIG. 13 illustrates a calibration in addition to a query on a value. Such a calibration is not a prerequisite (e.g., rules could also compare against fixed numbers), but might help to normalize among various humans in some instances. It also will be appreciated that rules may become much more involved and complex, e.g., relating various biosensor readings to one another. FIG. 18, for example, shows a complex event query that checks these indicators and generates an event that spots the process section to be revisited, in accordance with certain example embodiments. In the FIG. 18 example, an extraordinary situation is flagged if unhealthy movements make up more than 20% of the average posture measurements of a step. Of course, other metrics for this and/or other queries may be used in different instances.

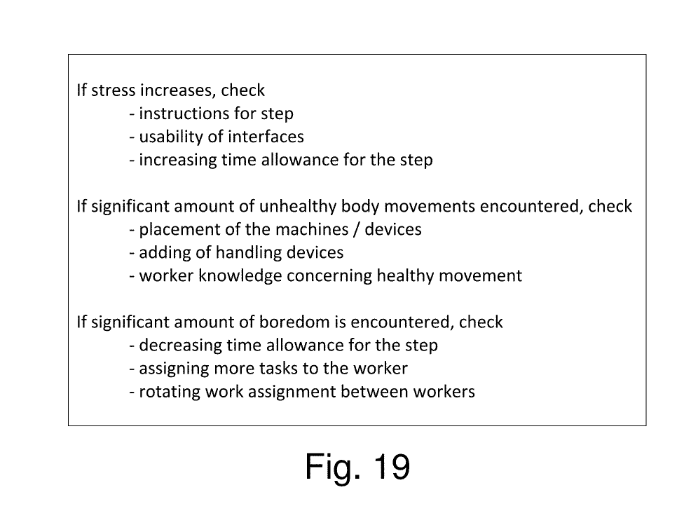

Certain worker conditions indicate options for process optimization, e.g., worker boredom can indicate unused worker time, possible lower performance of the worker, etc. The corresponding step(s) in the process can be highlighted such that the process engineer can investigate these situations for potential optimization. In addition, hints about suitable process adaptions can be given based on a rule set. FIG. 19, for example, is a sample rule set indicating suitable process adaptations based on step-related findings, which may be used in connection with certain example embodiments.

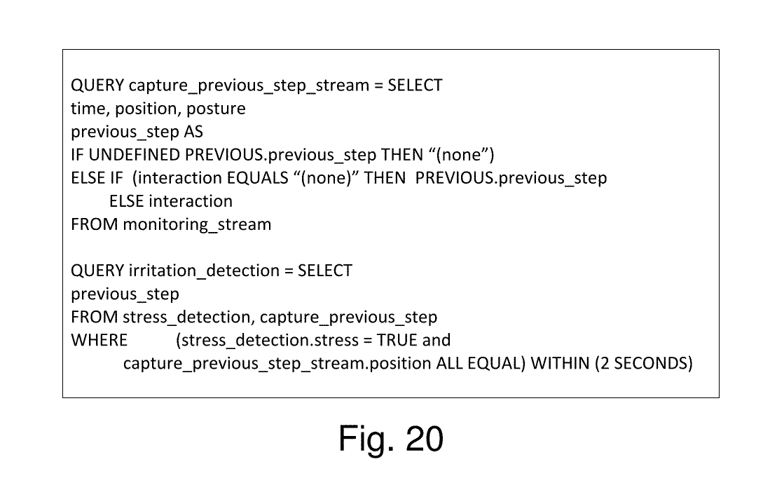

Analogously, the workers' postures captured by the monitoring component can be analyzed for patterns that correspond to unhealthy movement patterns, such as frequent back-straining movements of the same type (bending, spine rotation). The analysis may generate an alarm in these cases. See FIG. 20, which is a query that spots periods without movement and stress occurring at the same time, and relates these detections to the previous step in the virtual environment, which may be used in connection with certain example embodiments. Based on these analyses, the equipment can be rearranged or some tool (e.g., for lifting heavy loads) can be added or replaced, leading to better worker health, process efficiency improvements, etc. Health indicators can be computed from bio sensor readings, movement analysis and frequency, allowing for a health assessment of the overall process (step 1712).

Ultimately, process improvements can be derived based on the above-described and/or other factors, e.g., as summarized in FIG. 17 (step 1714).

In view of the foregoing, it will be appreciated that the example techniques described herein may be used to help reduce the overall time of a process execution, e.g., by reducing the production time of items by providing means to reduce the duration of manual steps in a process execution (which can, for example, be measured by time needed for the manual steps or overall process time), reduce workers' impediments and thus reduce the likelihood of errors caused by workers' stress or tiredness and increase the overall production quality (which can, for example, be measured by quality indicators, e.g. number of deficient products per time unit), reduce the time needed to automate new production processes and increases their initial quality (which can, for example, be measured by time span from start of process automation activity to first productive use of the process), and/or the like.

As noted above, the example techniques described herein may be used to create new workflows/processes. In this regard, certain example embodiments relate to a workflow generation system. A model store is configured to store a first computer-understandable, formalized representation of a process comprising process steps. A virtual reality model store is configured to store a second computer-understandable, formalized representation of the process and process steps, with the first and second representations being different from one another. A virtual reality controller including at least one processor and a memory includes instructions that are executable by the at least one processor to control the system to at least: present a virtual reality environment; monitor user actions in the presented virtual reality environment; execute a rule set on the monitored user actions to detect candidate process steps; responsive to the detection of a candidate process step: create an entry in the virtual reality model store for the respective detected candidate process step, and annotate the created entry with attributes related to the respective detected candidate process step; enable created entries to be added to the second representation as process steps thereof; and generate the first representation from the second representation.

In addition to the features of the previous paragraph, in certain example embodiments, the virtual reality environment may augment an at least partially physically-existing environment.

In addition to the features of the previous paragraph, in certain example embodiments, the augmentation may include simulated machinery operation, optionally performed in connection with corresponding physically-existing machinery that does not operate in the real world.

In addition to the features of any of the three previous paragraphs, in certain example embodiments, the system may be further controllable by the at least one processor to cause subsequent virtual executions of the process to be performed in connection with the new process steps.

In addition to the features of any of the four previous paragraphs, in certain example embodiments, the system may be further controllable by the at least one processor to suggest process improvements for, and/or perform process improvements in, subsequent virtual executions and/or subsequent real-world performance of the process.

In addition to the features of any of the five previous paragraphs, in certain example embodiments, each process step in the process may be classified as being one of a manual step and an automatic step, and the virtual reality controller may be configured to control the virtual execution so as to simulate process steps that are classified as being automatic steps and enable a human user to perform process steps that are classified as being manual steps.

In addition to the features of any of the six previous paragraphs, in certain example embodiments, at least one physical sensor may be attachable to the human user and configured to obtain biometric data of the human user, at least one camera may be configured to track movement of the human user during the virtual execution, and at least one user interface device may be configured to enable the human user to interact with the virtual reality environment; and the at least one physical sensor, the at least one camera, and the at least one user interface device may be in communication with the virtual reality controller such that output therefrom is monitorable in connection with monitoring of the user actions.

In addition to the features of the previous paragraph, in certain example embodiments, at least one rule in the rule set may help identify candidate process steps based on an identification of user movements as detected using the at least one camera and/or the at least one user interface device, intervening pauses suggestive of discrete actions, etc.

In addition to the features of either of the two previous paragraphs, in certain example embodiments, the virtual reality controller may be configured to respond to one or more predefined gestures, e.g., as detected by the at least one camera and/or the at least one user interface device.

In addition to the features of the previous paragraph, in certain example embodiments, predefined gestures may be usable to signify a new process step, new input material, new output material, process step transition, etc.

In addition to the features of the previous paragraph, in certain example embodiments, the rule set may include rules taking into account the predefined gestures.

In addition to the features of any of the 11 previous paragraphs, in certain example embodiments, a concept map may be configured to store mappings between counterpart concepts of the process that are present in the first and second representations.

In addition to the features of the previous paragraph, in certain example embodiments, the generation of the first representation from the second representation may be performed in connection with the concept map.

In addition to the features of the previous paragraph, in certain example embodiments, the system may be further controllable by the at least one processor to build the concept map by extracting process concepts from the first representation and virtual concepts from the second representation.

In addition to the features of the previous paragraph, in certain example embodiments, extracted virtual concepts may include types and actions associated therewith, and extracted process steps may include types associated therewith.

In addition to the features of any of the 15 previous paragraphs, in certain example embodiments, the attributes may include start and end timestamps, as well as associated (a) movements and/or (b) biometric data.

In addition to the features of any of the 16 previous paragraphs, in certain example embodiments, the first representation may be in a process modeling language and the second language may be in a virtual reality format.

In addition to the features of any of the 17 previous paragraphs, in certain example embodiments, the system may be further controllable by the at least one processor to receive manual confirmations before created entries are to be added to the second representation as process steps thereof.

In addition to the features of any of the 18 previous paragraphs, in certain example embodiments, the system may be further controllable by the at least one processor to receive user input facilitating creation of the process in the first and/or second representation(s), the user input optionally enabling creation of new process steps, editing of process steps already added thereto (e.g., whether originally added by a user or by the system in response to a detection), linking together of process steps, etc.

In addition to the features of any of the 19 previous paragraphs, in certain example embodiments, the system may be further controllable by the at least one processor to receive user input corresponding to concepts to be added to the first and/or second representations that are relevant thereto.

Certain example embodiments relate to a method of building a workflow, e.g., using the system of any one of the 20 previous paragraphs.

Certain example embodiments relate to a non-transitory computer readable storage medium storing instructions that, when executed by a processor of a computer system, may perform the method of the preceding paragraph.

It will be appreciated that as used herein, the terms system, subsystem, service, engine, module, programmed logic circuitry, and the like may be implemented as any suitable combination of software, hardware, firmware, and/or the like. It also will be appreciated that the storage locations, stores, and repositories discussed herein may be any suitable combination of disk drive devices, memory locations, solid state drives, CD-ROMs, DVDs, tape backups, storage area network (SAN) systems, and/or any other appropriate tangible non-transitory computer readable storage medium. Cloud and/or distributed storage (e.g., using file sharing means), for instance, also may be used in certain example embodiments. It also will be appreciated that the techniques described herein may be accomplished by having at least one processor execute instructions that may be tangibly stored on a non-transitory computer readable storage medium.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed is:

1. A workflow improvement system, comprising:
a model store configured to store a first computer-understandable, formalized representation of a process comprising process steps;
a virtual reality model store configured to store a second computer-understandable, formalized representation of the process and process steps, the first and second representations being different from one another;
a concept map configured to store mappings between counterpart concepts of the process that are present in the first and second representations; and
at least one processor and a memory including instructions that are executable by the at least one processor to control the system to at least:
receive output from virtual execution of at least a portion of the process in a virtual reality environment presented in connection with the second representation stored in the virtual reality model store;
identify a part of the second representation associated with the received output;
execute a rule set on the received output to detect anomalous behavior in the virtual execution; and
responsive to a detection of anomalous behavior:
consult the concept map to identify a part of the first representation associated with the identified part of the second representation; and
annotate the identified part of the first representation with attributes of the anomalous behavior.

2. The system of claim 1, wherein the rule set includes one or more rules configured to distinguish between first and second levels of anomalous behaviors, the first level of anomalous behavior corresponding to an action performed in the virtual reality environment that cannot actually be performed, the second level of anomalous behavior corresponding to an action performed in the virtual reality environment that can actually be performed but is being performed in the virtual reality environment in a manner outside of that which is expected.

3. The system of claim 1, wherein the system is further controllable by the at least one processor to update the first representation to include new process steps performed during the virtual execution and determined from the received output.

4. The system of claim 3, wherein the system is further controllable by the at least one processor to cause subsequent virtual executions of the process to be performed in connection with the new process steps.

5. The system of claim 1, wherein the system is further controllable by the at least one processor to suggest process improvements for, and/or perform process improvements in, subsequent virtual executions and/or subsequent real-world performance of the process.

6. The system of claim 1, wherein each process step in the process is classified as being one of a manual step and an automatic step, and wherein a virtual reality control system is configured to control the virtual execution so as to simulate process steps that are classified as being automatic steps and enable a human user to perform process steps that are classified as being manual steps.

7. The system of claim 6, wherein the virtual reality control system includes at least one physical sensor attachable to the human user and configured to obtain biometric data of the human user, at least one camera configured to track movement of the human user during the virtual execution, and at least one user interface device configured to enable the human user to interact with the virtual reality environment, and
wherein receivable output includes data from the at least one physical sensor, the at least one camera, and the at least one user interface device.

8. The system of claim 7, wherein the system is further controllable by the at least one processor to derive a personal state of the human user based on received output corresponding to data from the at least one physical sensor.

9. The system of claim 8, wherein the personal state includes physical and psychological states observed about and/or inferred from the human user.

10. The system of claim 8, wherein the rule set includes at least one rule programmed to take into account a personal state of a human user.

11. The system of claim 8, wherein the rule set includes at least one rule programmed to take into account a personal state of a human user and baseline data for that human user and/or a group of human users.

12. The system of claim 1, wherein the system is further controllable by the at least one processor to build the concept map by extracting virtual concepts from the first representation and process concepts from the second representation.

13. The system of claim 12, wherein extracted virtual concepts include types and actions associated therewith, and wherein extracted process steps include types associated therewith.

14. The system of claim 1, wherein the attributes of the anomalous behaviors include associated start and end timestamps, as well as associated (a) movements and/or (b) biometric data.

15. The system of claim 1, wherein the system is further controllable by the at least one processor to respond to a detection of non-anomalous behavior by:
consulting the concept map to identify a part of the first representation associated with the identified part of the second representation; and
annotating the identified part of the first representation with attributes of the non-anomalous behavior.

16. A method for improving a process comprising process steps, the process being represented by first and second computer-understandable, formalized representations thereof, the first representation being in a process modeling language and the second language being in a virtual reality format, the method comprising:
receiving output from virtual execution of at least a portion of the process in a virtual reality environment presented in connection with the second representation;
identifying a part of the second representation associated with the received output;
executing, using processing resources including at least one processor and a memory, a programmable rule set on the received output to detect anomalous behavior in the virtual execution, the rule set being stored to a non-transitory computer readable storage medium; and
responsive to a detection of anomalous behavior:
identifying a part of the first representation corresponding to the identified part of the second representation; and
annotating the identified part of the first representation with attributes of the anomalous behavior.

17. A non-transitory computer readable storage medium including instructions configured to help improve a process comprising process steps, the process being represented by first and second computer-understandable, formalized representations thereof, the first representation being in a process modeling language and the second language being in a virtual reality format, the instructions being executable by at least one processor to perform functionality comprising:
receiving output from virtual execution of at least a portion of the process in a virtual reality environment presented in connection with the second representation;
identifying a part of the second representation associated with the received output;
executing, using processing resources including at least one processor and a memory, a programmable rule set on the received output to detect anomalous behavior in the virtual execution; and
responsive to a detection of anomalous behavior:
identifying a part of the first representation corresponding to the identified part of the second representation; and
annotating the identified part of the first representation with attributes of the anomalous behavior.

18. The non-transitory computer readable storage medium of claim 17, wherein the rule set includes one or more rules configured to distinguish between first and second levels of anomalous behaviors, the first level of anomalous behavior corresponding to an action performed in the virtual reality environment that cannot actually be performed, the second level of anomalous behavior corresponding to an action performed in the virtual reality environment that can actually be performed but is being performed in the virtual reality environment in a manner outside of that which is expected.

19. The non-transitory computer readable storage medium of claim 17, further comprising instructions for updating the first representation to include new process steps performed during the virtual execution and determined from the received output.

20. The non-transitory computer readable storage medium of claim 17, further comprising instructions for suggesting process improvements for, and/or performing process improvements in, subsequent virtual executions and/or subsequent real-world performance of the process.

21. The non-transitory computer readable storage medium of claim 17, wherein each process step in the process is classified as being one of a manual step and an automatic step, and wherein a virtual reality control system is configured to control the virtual execution so as to simulate process steps that are classified as being automatic steps and enable a human user to perform process steps that are classified as being manual steps.

22. The non-transitory computer readable storage medium of claim 21, wherein the virtual reality control system includes at least one physical sensor attachable to the human user and configured to obtain biometric data of the human user, at least one camera configured to track movement of the human user during the virtual execution, and at least one user interface device configured to enable the human user to interact with the virtual reality environment, and
wherein receivable output includes data from the at least one physical sensor, the at least one camera, and the at least one user interface device.

23. The non-transitory computer readable storage medium of claim 22, wherein the at least one processor is further controllable to derive a personal state of the human user based on received output corresponding to data from the at least one physical sensor, the personal state including physical and psychological states observed about and/or inferred from the human user.

24. The non-transitory computer readable storage medium of claim 17, wherein the attributes of the anomalous behaviors include associated start and end timestamps, as well as associated (a) movements and/or (b) biometric data.

25. The non-transitory computer readable storage medium of claim 17, further comprising instructions for responding to a detection of non-anomalous behavior by:
consulting the concept map to identify a part of the first representation associated with the identified part of the second representation; and
annotating the identified part of the first representation with attributes of the non-anomalous behavior.
